(19) United States
(12) Patent Application Publication
(10) Pub. No.: US 2026/0117088 A1
(43) Pub. Date: Apr. 30, 2026

(54) MONOMER MIXTURE COMPRISING AN N-VINYL MONOMER AND A BUTENOLIDE MONOMER AND COATING COMPOSITIONS DERIVED THEREFROM

(71) Applicant: AKZO NOBEL COATINGS INTERNATIONAL B.V., Amsterdam (NL)

(72) Inventors: Mathieu Louis Philippe Lepage, Amsterdam (NL); Bernard Lucas Feringa, Amsterdam (NL); Johannes George Hendrik Hermens, Amsterdam (NL); Keimpe Jan Van Den Berg, Amsterdam (NL); Niels Elders, Amsterdam (NL)

(21) Appl. No.: 19/137,176

(22) PCT Filed: Dec. 15, 2023
(86) PCT No.: PCT/EP2023/086168

§ 371 Date: Jun. 9, 2025

(30) Foreign Application Priority Data
Dec. 16, 2022 (EP) 22214135.0

(51) Int. Cl. C09D 167/06

(52) U.S. Cl. CPC C09D 167/06

(57) ABSTRACT

A radiation-curable coating composition, comprising a monomer mixture comprising: a) at least one butenolide monomer A, which butenolide monomer is a substituted-5-hydroxy-2(5H)-furanone of general formula (I) wherein: n is 0 or an integer of from 1 to 5; m is 0 or 1; R¹ is alkyl or aryl; X is any one of —C(O)—, —C(O)O—, —C(O)NR²—, —S(O)—, —S(O2)—, —C(O)S—, —C(S)S— and —C(S)NR²—; wherein R² is hydrogen, alkyl or aryl; and b) at least one N-vinyl monomer B, which N-vinyl monomer is a compound of general formula (II) wherein R⁴ and R⁵ are each independently any one of hydrogen, alkyl, aryl, heteroalkyl or heteroaryl and Y is selected from O, NR⁶ and S; and wherein either: i) a is 1 and b is 1; or ii) a is 0 and b is 2; and wherein at least one monomer of A and B comprises at least two vinyl groups.

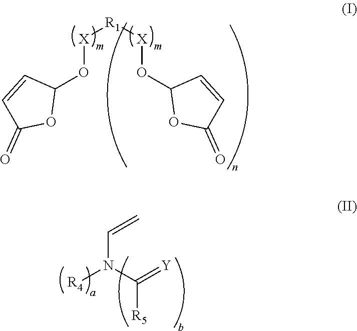

### CROSS REFERENCE TO RELATED APPLICATION

This application is a 35 U.S.C. § 371 national phase application of PCT Application No. PCT/EP2023/086168 (published as WO/2024/126832), filed Dec. 15, 2023, which claims the benefit of priority to EP Application No. 22214135.0, filed Dec. 16, 2022, each of which is incorporated herein by reference in their entirety.

### TECHNICAL FIELD

The present disclosure relates to a monomer mixture comprising an N-vinyl monomer and a butenolide monomer. It also relates to a radiation-curable coating composition comprising the monomer mixture, a binder polymer obtainable by polymerizing the monomer mixture, a coating composition comprising a binder polymer and a substrate coated with a coating deposited from the coating composition.

### BACKGROUND

Polyacrylates or other addition polymers are widely used as film-forming polymers in paints and coatings. Film-forming polymers are also referred to as binder polymers since such polymers have the role to bind any particulate material such as color pigments and extender pigments together.

Radiation-curable coating compositions containing double bonds that can be activated by actinic radiation, such as UV light or electron beam radiation, are well known in the art. Reference herein to actinic radiation is to electromagnetic, ionizing radiation, in particular electron beam radiation, UV light and visible light. Radiation-curable coating compositions typically cross-link through radical polymerization of monomers with an ethylenically unsaturated group, such as an acryloyl, methacryloyl, or vinyl group. Examples of such monomers include acrylic acid, methacrylic acid, alkyl esters of (meth)acrylic acid, styrene, alkyl-substituted styrene, vinyl esters, and vinyl ethers. The monomers are usually prepared from petrochemical raw materials.

Polyacrylates or other addition polymers are typically prepared by radical polymerization of monomers with an ethylenically unsaturated group, such as an acrylic, methacrylic, or vinyl group. Examples of such monomers include acrylic acid, methacrylic acid, alkyl esters of (meth)acrylic acid, styrene, alkyl-substituted styrene, vinyl esters, and vinyl ethers. The monomers are usually prepared from petrochemical raw materials.

There is an increasing demand for chemical products prepared from renewable feedstock. Binder polymers at least partly prepared from renewable feedstock are known in the art. Alkyd resins for example comprise a relatively high content of fatty acids obtained from vegetable oil.

In WO2009/080599 is disclosed a process for preparing polymerizable ethylenically unsaturated macromonomers from vegetable oil that can be used to prepare an addition polymer for use in coating compositions.

In U.S. Pat. No. 4,954,593 is disclosed a copolymer for use as a protective coating that is prepared by combining a furanone monomer and a vinyl ether monomer in a molar ratio of about one. The copolymer may be prepared by photopolymerization or by solution polymerization in the presence of a free-radical initiator.

Butenolides are ethylenically unsaturated furanoic compounds that can be prepared from carbohydrates, i.e. a renewable feedstock. Carbohydrate feedstock such as starch, cellulose or carbohydrate-containing bio-waste can be converted into furfural, hydroxymethylfurfural, or related furan derivatives by dehydration and then oxidized into lactones or other butenolides. Preparation of butenolides is for example described in Chapter II of J. C. de Jong, Asymmetric Diels-Alder reactions with 5-menthyloxy-2(5H)-furanones, Thesis University of Groningen, 2006, accessible via https://www.rug.nl/research/portal/en/publications/asymmetric-dielsalder-reactions-with-5menthyloxy25hfuranones(f0ab6c00-8c6c-4ccc-90aa-3ef05f759fa4).html.

Poskonin et al. have disclosed in Russian Journal of Organic Chemistry 35 (1999) 721-726 copolymers prepared by radical polymerization of 4-alkoxy-2-butenolide (5-alkoxy-2(5H)-furanone) and styrene, methyl methacrylate, or vinyl acetate. Use of such copolymers for synthesis of physiologically active substances is suggested. Poskonin et al. have further disclosed in Russian Journal of Organic Chemistry 35 (1997) 520-523 oligomers prepared by radical polymerization of 4-acetoxy-2-butenolide (5-acetoxy-2(5H)-furanone) and styrene, methyl methacrylate, or vinyl acetate. Number average molecular weights of from 1860 to 6460 were achieved.

WO2021/084066 describes copolymerization of 5-alkoxy-2(5H)-furanones with selected vinyl ethers or vinyl esters and the use of the resulting copolymers as a binder in a polymer coating composition.

WO2021/259819 describes a radiation-curable copolymer coating composition comprising a 5-hydroxy or 5-alkoxy-2(5H)-furanone compound and a compound with two or more vinyl ether or vinyl ester groups.

Trost and Toste have disclosed in J. Am. Chem. Soc. 2003, 125, 3090-3100 two butenolide compounds: 2-tert-Butoxycarbonyloxy-5-oxo-2,5-dihydrofuran and 2-benzoyloxy-5-oxo-2,5-dihydrofuran with application in introducing chirality into synthesis of aflatoxins.

U.S. Pat. No. 3,929,735 describes a coplymer of an N-vinyl lactam, for example N-vinyl-2-pyrrolidone with an unsaturated lactone, for example a butenolide. It does not mention the use of such a copolymer in a radiation-curable coating composition.

There is a need for coating compositions, which can at least partially be obtained from renewable feedstock and which have higher reactivity and additional functionality compared with known binder polymers.

### SUMMARY

It has now been found that a hard and chemically resistant cured coating can be obtained by radiation curing, activated by actinic radiation such as visible or UV light or electron beam radiation, of a composition comprising a 5-substituted butenolide monomer and a monomer comprising one or more N-vinyl groups. The coatings formed have properties that make them suitable as protective or decorative coatings. In addition, a hard coating can be deposited from a coating composition comprising a binder obtainable by copolymerizing a mixture of 5-substituted butenolide monomer and a monomer comprising one or more N-vinyl groups.

Accordingly, the disclosure provides in a first aspect a radiation-curable coating composition, comprising a monomer mixture, which monomer mixture comprises:
a) at least one butenolide monomer A, which butenolide monomer is a substituted-5-hydroxy-2(5H)-furanone of general formula (I):

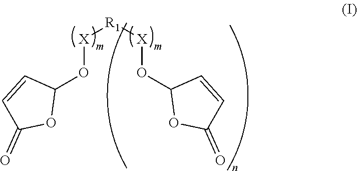

n is 0 or an integer of from 1 to 5;
m is 0 or 1;
R¹ is alkyl or aryl;
X is any one of —C(O)—, —C(O)O—, —C(O)NR²—, —S(O)—, —S(O₂)—, —C(O)S—, —C(S)S— and —C(S)NR²—; wherein R² is hydrogen, alkyl or aryl;
or wherein, when n is 0, R¹ and R² together with the nitrogen atom through which they are linked form a nitrogen-containing heterocyclic group or nitrogen-containing heteroaryl group; and
b) at least one N-vinyl monomer B, which N-vinyl monomer is a compound of general formula (II):

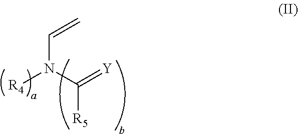

wherein R⁴ and R⁵ are each independently any one of hydrogen, alkyl, aryl, heteroalkyl or heteroaryl and Y is selected from O, NR⁶ and S; wherein R⁶ is hydrogen, alkyl, aryl, heteroalkyl or heteroaryl; wherein any two of R⁴, R⁵ and R⁶ together with the atoms through which they are linked form a nitrogen-containing cyclic heteroalkyl or nitrogen-containing heteroaryl group; and wherein either: i) a is 1 and b is 1; or ii) a is 0 and b is 2;
wherein at least one monomer of A and B comprises at least two vinyl groups; and wherein the coating composition is free of a compound with two or more acryloyl or methacryloyl groups.

In a second aspect, the disclosure provides a monomer mixture which monomer mixture comprises:
a) at least one butenolide monomer A, which butenolide monomer is a substituted 5-hydroxy-2(5H)-furanone of general formula (I):

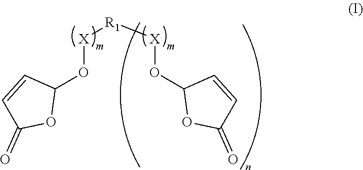

n is 0 or an integer of from 1 to 5;
wherein when n is 0, m is 1 and when n is an integer of from 1 to 5, m is 0 or 1;
R¹ is alkyl or aryl;
X is any one of —C(O)—, —C(O)O—, —C(O)NR²—, —S(O)—, —S(O₂)—, —C(O)S—, —C(S)S— and —C(S)NR²—; wherein R² is hydrogen, alkyl or aryl;
or wherein, when n is 0, R¹ and R² together with the nitrogen atom through which they are linked form a nitrogen-containing heterocyclic group or nitrogen-containing heteroaryl group; and
b) at least one N-vinyl monomer B, which N-vinyl monomer is a compound of general formula (II):

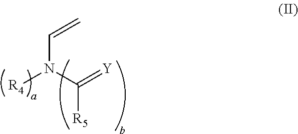

wherein R⁴ and R⁵ are each independently any one of hydrogen, alkyl, aryl, heteroalkyl or heteroaryl and Y is selected from O, NR⁶ and S; wherein R⁶ is hydrogen, alkyl, aryl, heteroalkyl or heteroaryl; wherein any two of R⁴, R⁵ and R⁶ together with the atoms through which they are linked form a nitrogen-containing cyclic heteroalkyl or nitrogen-containing heteroaryl group; and wherein either: i) a is 1 and b is 1; or ii) a is 0 and b is 2.

In a third aspect, the disclosure provides a binder polymer obtainable by copolymerizing a monomer mixture as defined herein.

In a fourth aspect, the disclosure provides a coating composition comprising a binder polymer as defined herein.

In a fifth aspect, the disclosure provides a substrate coated with a coating deposited from a radiation-curable coating composition or from a coating composition as defined herein.

The binder polymer has been found to provide a tack-free coating film with good hardness properties if applied to a substrate and allowed to dry.

The binder polymer has a polymer backbone with functionality which advantageously can provide possibilities for crosslinking, for example with a hydroxyl or thiol functional crosslinker or with a polymer with hydroxyl or thiol functionality.

### DETAILED DESCRIPTION

The radiation-curable coating composition comprises a) one or more butenolide monomer A; and b) one or more vinyl monomer B, wherein at least one monomer of A and B comprises at least two vinyl groups. The presence of a monomer having at least two vinyl groups is necessary to act as a cross-linker in the coating composition.

The binder polymer is obtainable by copolymerizing a monomer mixture comprising at least one butenolide monomer A and at least one N-vinyl monomer B.

As used herein the term one or more with reference to each of A and B means that multiple different monomers of A and respectively B may be present in the coating composition. For example a composition may comprise one butenolide monomer A and one vinyl monomer B. Alternatively, it may comprise one butenolide monomer A and two vinyl monomers B, which vinyl monomers B are different from each other. Alternatively, it may comprise two butenolide monomers A, which butenolide monomers A are different from each other, and one butenolide monomer B.

A vinyl group has an α-C and β-C determined by proximity to another functional group in the molecule. As used herein difference in ¹³C chemical shift between the α-C and β-C of the vinyl group can be determined from the chemical shift as reported in the Spectral Database for Organic Compounds (https://sdbs.db.aist.go.jp/sdbs/cgi-bin.direct_frame_top.cgi), managed by the National Institute of Advanced Industrial Science and Technology.

As used herein an alkyl radical may be branched, unbranched, linear or cyclic. The alkyl radical may be saturated or unsaturated. It may be substituted or unsubstituted. An alkyl radical typically contains from 1 to 20 carbon atoms, in particular 1 to 12 carbon atoms, 1 to 6 carbon atoms or 1 to 4 carbon atoms. An alkyl radical may contain from 2 to 20 carbon atoms, in particular 2 to 12 carbon atoms, 2 to 6 carbon atoms or 2 to 4 carbon atoms. An alkyl radical may contain from 1 to 3 carbon atoms, for example 1, 2 or 3 carbon atoms. Examples of alkyl radials are methyl, ethyl, n-propyl, isopropyl, n-butyl, tert-butyl, sec-butyl, isobutyl, hexyl, lauryl, oleyl and cyclohexyl.

As used herein, cycloalkyl means a cyclic alkyl radical. Cyclic heteroalkyl means a cycloalkyl radical wherein at least one carbon in the cycle is substituted with a heteroatom. A heteroatom may be nitrogen, oxygen or another atom other than carbon. A cyclic heteroalkyl radical may be a nitrogen-containing cyclic heteroalkyl.

As used herein aryl means an aromatic radical. An aryl radical may be substituted or unsubstituted. An aryl radical typically contains 6 or 10 carbon atoms. An aryl radical may be phenyl or naphthyl, in particular phenyl. Heteroaryl means an aryl radical comprising a heteroatom, i.e. an atom other than carbon, in an aromatic ring. A heteroaryl radical may be substituted or unsubstituted. A heteroaryl radical typically contains from 5 to 12 carbon atoms. A typical hetero atom is oxygen or nitrogen.

In various embodiments a is 1 and b is 1. In an alternative embodiment, a is 0 and b is 2.

R⁴ is any one of hydrogen, alkyl, aryl or heteroalkyl. In various embodiments R⁴ is hydrogen, alkyl or aryl. In particular, R⁴ may be hydrogen or C₁-C₁₂ alkyl.

Each R⁵ is independently any one of hydrogen, alkyl, aryl or heteroalkyl. In various embodiments R⁵ is hydrogen, alkyl or aryl. In particular, each R⁵ may be hydrogen or C₁-C₁₂alkyl.

Y is selected from O, NR⁶ and S; wherein R⁶ is hydrogen, alkyl, aryl, heteroalkyl or heteroaryl. In various embodiments Y is NR⁶. In particular, Y may be NR⁶, wherein R⁶ is hydrogen or C₁-C₁₂ alkyl.

In various embodiments, any two of R⁴, R⁵ and R⁶ together with the atoms through which they are linked form a nitrogen-containing cyclic heteroalkyl or nitrogen-containing heteroaryl group.

In various embodiments a is 1, b is 1 and R⁴ and R⁵ together with the atoms through which they are linked form a nitrogen-containing cyclic heteroalkyl or nitrogen-containing heteroaryl group. In particular, R⁴ and R⁵ together with the atoms through which they are linked form a nitrogen-containing cyclic heteroalkyl or nitrogen-containing heteroaryl group and Y is O. For example, R⁴ and R⁵ together with the atoms through which they are linked form a 5 to 7 membered cyclic heteroalkyl group comprising one nitrogen atom and 4 to 6 carbon atoms. In this way N-vinyl monomer B is a vinyl lactam, for example N-vinyl monomer B may be N-vinyl pyrrolidone or N-vinyl caprolactam.

In various embodiments, a is 1, b is 1, Y is NR⁶, and R⁴ and R⁶ together with the atoms through which they are linked form a nitrogen-containing cyclic heteroalkyl or nitrogen-containing heteroaryl group. For example, R⁴ and R⁶ together with the atoms through which they are linked form a 5 to 7 membered heteroaryl group. For example a 5 to 7 membered heteroaryl group comprising 1 to 2 nitrogen atoms and 3 to 6 carbon atoms. R⁵ may be hydrogen or C₁-C₁₂ alkyl, for example hydrogen. N-vinyl monomer B may be for example N-vinylimidazole.

In various embodiments a is 0, b is 2, Y is O and each R⁵ together with the atoms through which they are linked form a nitrogen-containing cyclic heteroalkyl or nitrogen-containing heteroaryl group. For example, each R⁵ together with the atoms through which they are linked may form a 5 to 7 membered cyclic heteroalkyl group. This cyclic heteroalkyl group may be annulated, for example with a phenyl or cyclohexyl group. An annulated cyclic heteroalkyl may be an isoindoline group. N-vinyl monomer B may be for example N-vinyl phthalimide, N-vinylsuccinimide or N-vinylmaleimide; in particular N-vinyl phthalimide.

In various embodiments, N-vinyl compound B is a monovinyl N-vinyl compound and/or a (meth)acryloyl monomer with a molecular weight in the range of from 50 to 800 g/mol, more preferably of from 100 to 500 g/mol.

In various embodiments N-vinyl monomer B has at least two vinyl groups. In the vinyl monomer of formula (II), R⁴ or R⁵ comprises at least one vinyl group. For example, R⁴ comprises at least one vinyl group or R⁵ comprises at least one vinyl group or both R⁴ and R⁵ comprise at least one vinyl group.

The radiation-curable coating composition may comprise at least two N-vinyl monomers B. At least one N-vinyl monomer B may comprise at least two N-vinyl groups. For example, the radiation-curable coating composition may comprise one N-vinyl monomer B, which is a monovinyl compound and one N-vinyl monomer B which is a divinyl compound.

In various embodiments an N-vinyl monomer B has at least two vinyl groups and is a di-N-vinyl compound.

Examples of vinyl monomer B with at least two N-vinyl groups are N-vinyl substituted polycarboxamides, for example adipamide, succinamide, terephthalamide, isophthalamide, benzene-tricarboxamides.

N-vinyl monomer B may have a molecular weight in the range of from 100 to 3,000 g/mol. If N-vinyl monomer B is a compound with a polymeric backbone, the molecular weight is preferably in the range of from 500 to 3,000 g/mol.

Each m may independently be 0 or 1. In the case where m is 0, X is not present. In the case where m is 1, X is present. In various embodiments, in particular in the monomer mixture defined herein, when n is 0, m is 1 and when n is an integer of from 1 to 5, m is 0 or 1.

X is any one of —C(O)—, —C(O)O—, —C(O)NR²—, —S(O)—, —S(O₂)—, —C(O)S—, —C(S)S— and —C(S)NR²—; wherein R² is hydrogen, alkyl or aryl, or, when n is 0, R¹ and R² together with the nitrogen atom through which they are linked may form a nitrogen-containing heterocyclic group or nitrogen-containing heteroaryl group. In various embodiments, X is —C(O)—, —C(O)O— or —C(O)NR²—, for example —C(O)—.

R¹ may be C₁-C₂₀ alkyl, C₅-C₇ cycloalkyl or phenyl. In various embodiments, R¹ may be C₂-C₁₂ alkyl. R¹ may be branched or unbranched, substituted or unsubstituted C₁-C₁₂ alkyl. In another embodiment, R¹ may be C₅-C₇ cycloalkyl. In another embodiment R¹ may be phenyl.

In various embodiments, R³ may be hydrogen or C₁-C₁₂ alkyl. In particular, R³ may be hydrogen.

n is 0 or an integer of from 1 to 5, for example 1, 2, 3, 4, or 5. In particular, n is 0.

If n is an integer with a value in the range of from 1 to 5, butenolide monomer A is an oligomer obtainable by reacting a multifunctional scaffold having in the range of from 2 to 6 reactive groups with 5-hydroxy-2(5H)-furanone. The multifunctional scaffold may for example have from 1 to 40 carbon atoms.

Examples of suitable multifunctional scaffolds include diols, for example ethylene glycol, propylene glycol, butylene glycol, isosorbide, 1,3-propanediol, 1,4-butanediol, 1,5-pentanediol, 1,6-hexanediol, polyethylene glycol, polypropylene glycol, cyclohexanedimethanol, 2,2,4,4-tetramethyl-1,3-cyclobutanediol, tricyclodecane dimethanol, dimer fatty acid-based diols like Pripol 2033 (a C36 aliphatic diol); triols for example glycerol, trimethylolpropane, trimethylolethane, and 1,3,5-tris(2-hydroxyethyl)isocyanurate; tetraols such as pentaerythritol and di-trimethylolpropane; and hexols such as dipentaerythritol; polyacids for example oxalic acid, malonic acid, succinic acid, maleic acid, fumaric acid, adipic acid, citric acid, propane-1,2,3-tricarboxylic acid, trimesic acid and the corresponding thioacid, isocyanate and thiocyanate counterparts. Other examples of suitable scaffolds include alkyl carbonate or chloroformate derivatives of polyols such as ethylene glycol, propylene glycol, glycerol, cyclohexanedimethanol or pentaerythritol.

In various embodiments, n is 0, m is 1, X is —C(O)— and R¹ is C₁-C₁₂ alkyl, for example methyl. In another embodiment, n is 0, m is 0 and R¹ is C₁-C₁₂ alkyl, for example methyl.

The monomer mixture may have any suitable molar ratio of furanone moieties to vinyl moieties. In various embodiments, the molar ratio of furanone moieties to vinyl moieties is in the range of from 1:10 to 10:1, in particular from 1:5 to 5:1, for example from 1:3 to 3:1, from 1:2 to 2:1, or even from 1:1.5 to 1.5:1.

In various embodiments, the weight fraction of monomers comprising at least two vinyl groups in the composition is at most 5 wt. %.

In various embodiments, the radiation-curable coating composition is free of a compound with two or more acryloyl or methacryloyl groups. The presence of such compound may have a negative effect on film formation.

The total amount of butenolide monomer A and vinyl monomer B in the radiation-curable coating composition may be in the range of from 70 to 100 wt %, more preferably from 80 to 100 wt %, even more preferably of from 90 to 100 wt %.

The coating composition is radiation-curable. The coating composition may be cured by photoinitiation, i.e. by radiation with visible light or UV light. In various embodiments the composition further comprises c) a photo-initiator.

The photo-initiator may be one photo initiator or a mixture of two or more thereof. Photo-initiators generate free radicals when exposed to radiation energy in the visible light or UV light wavelength range. Any suitable photo-initiator known in the art may be used, depending on the wavelength. Suitable photo-initiators include benzoin derivatives, benzile ketales, α-hydroxyalkylphenones, monoacylphosphine oxide (MAPO) and bisacylphosphine oxides (BAPO), such as diphenyl(2,4,6-trimethylbenzoyl)phosphine oxide, 1-hydroxy-cyclohexyl-phenyl-ketone, bis(2,4,6-trimethylbenzoyl)-phenylphosphineoxide, bis(2,6-dimethoxybenzoyl)-2,4,4-trimethylpentyl-phosphine oxide, 2-hydroxy-2-methyl-1-phenyl-propan-1-one, 2-methyl-1[4-(methylthio)phenyl]-2-morpholono-propan-1-one, a phenyl glyoxylic acid methyl ester. Mixtures of these compounds may also be employed.

The photo-initiator may be present in an amount of from 0.1 to 10 wt %, for example of from 0.5 to 5.0 wt %, based on the total weight of the coating composition.

Alternatively, the curing of the radiation-curable coating composition may be initiated by electron beam or by gamma radiation. For initiation by electron beam or gamma radiation, no photo-initiator is needed.

The radiation-curable coating composition may be a powder coating composition or a liquid coating composition, preferably a liquid coating composition. The radiation-curable coating composition preferably is an essentially solvent-free liquid coating composition. Reference herein to an essentially solvent-free coating composition is to a coating composition comprising at most 1 wt % of organic solvent, more preferably at most 0.5 wt %, still more preferably 0 wt %.

In case the viscosity of butenolide monomer A and vinyl monomer B is undesirably high the coating composition may comprise some organic solvent to control the viscosity. Preferably, the coating composition comprises at most 30 wt % organic solvent, more preferably at most 20 wt %, even more preferably at most 10 wt %, still more preferably at most 5 wt % or at most 2 wt %.

Suitable organic solvents are solvents in which butenolide monomer A and vinyl monomer B and the cured polymer dissolve at polymerization conditions. The organic solvent may be an oxygenated organic solvent, for example an alcohol, ketone, ester or ether. In particular, the solvent is a glycol ether, glycol ester or an alkyl acetate, for example 1-methoxy-2-propanol or butyl acetate.

The radiation-curable coating composition is not a waterborne coating composition, i.e. water is not the liquid medium in which butenolide monomer A and N-vinyl monomer B are dissolved or dispersed. The radiation-curable coating composition may comprise a small amount of water, for example water that is contained in additives comprised in the coating composition. In various embodiments, the radiation-curable coating composition comprises less than 5 wt % water, more preferably less than 1 wt %.

The radiation-curable coating composition may comprise further ingredients commonly used in coating compositions such as color pigments, extender pigments, and one or more additives such as for example light stabilizers, other stabilizers, defoaming agents, matting agents, wetting agents, or flow agents.

Radiation-curing the radiation-curable coating composition may be by exposing the coating composition to visible light or UV radiation, electron beam radiation, or gamma radiation, to form a cured coating.

The radiation-curable coating composition may be applied to the substrate by conventional techniques, including spraying, rolling, blade-coating, pouring, brushing or dipping. After evaporation of any organic solvent and/or water, if present, the coating composition results in a coating that is from dust-dry to very tacky. Curing is then induced by means of radiation. Any suitable source of radiation can be used. In particular, radiation curing may be by electron beam radiation, UV radiation or visible light radiation.

In various embodiments, the radiation-curable coating composition further comprises c) a photo-initiator and the radiation-curable coating composition is cured by exposing the coating composition to visible light or UV radiation, for example to visible light with a wavelength in the range of from 400 to 600 nm or to UV radiation with a wavelength in the range of from 200 to 400 nm, in particular to UV radiation with a wavelength in the range of from 280 to 400 nm, or preferably of from 320 to 400 nm (UV-A radiation).

For UV radiation, Hg lamps, metal halide lamps, xenon lamps, or UV-LED lamps may for example be used. It is preferred to use UV-LED lamps.

Radiation curing of the radiation-curable coating composition can be done at ambient conditions, e.g. room temperature and atmospheric pressure. Reference herein to room temperature is to a temperature in the range of from 15 to 30° C. The curing may be accelerated by post-heating, for example post-heating to a temperature in the range of from 40 to 100° C., preferably of from 50 to 80° C.

In one aspect, the disclosure relates to a substrate coated with a coating deposited from a radiation-curable coating composition. For example the coated substrate may be obtainable by a method comprising:
providing a substrate;
applying a radiation-curable coating composition as defined herein to the substrate;
and
radiation-curing the coating composition to form a cured coating.

The substrate may be any suitable substrate, such as for example wood, polymer, composite, metal or mineral substrate. The substrate may be a primed or bare substrate.

In various embodiments, the monomer mixture may comprise further ethylenically unsaturated monomers other than butenolide monomer A and N-vinyl monomer B that can be copolymerized by radical polymerization. Examples of such further monomers are acrylic acid, methacrylic acid, alkyl esters of (meth)acrylic acid, styrene, methylene malonates, itaconic acid, vinyl acetate, divinyl ethers such as ethyleneglycol divinyl ether, diethyleneglycol divinyl ether, triethyleneglycol divinyl ether, 1,4-butanediol divinyl ether, and trivinyl ethers such as trimethylolpropane trivinyl ether. The presence of divinyl ethers in the monomer mixture provides a binder polymer with crosslinking functional groups.

In various embodiments, the monomer mixture comprises less than 50 mol % of further ethylenically unsaturated monomers, for example less than 30 mol %, less than 20 mol %, or less than 10 mol %. In various embodiments, the monomer mixture comprises in the range of from 1 to 50 mol % of further ethylenically unsaturated monomers, for example from 2 to 30 mol %, or from 5 to 20 mol %. In another embodiment, the monomer mixture is free of further ethylenically unsaturated monomers.

The copolymerization is a radical polymerization process. Conditions that allow the monomers to copolymerize into an addition polymer by radical polymerization are well-known in the art. Suitable conditions typically include the presence of an initiator.

The co-polymerization may be carried out in an organic solvent (solvent polymerization). In solvent polymerization, the monomer mixture is dissolved in a suitable organic solvent, heated to the desired reaction temperature and a suitable initiator is added in a suitable amount. Typically, the temperature during solvent polymerization is in the range of from 50° C. to 180° C., for example from 70° C. to 160° C. It will be appreciated that the optimum polymerization temperature will depend on the decomposition temperature of the initiator used and the boiling temperature of the monomers at the pressure at which the polymerization is carried out. The monomer mixture may be dissolved in any suitable solvent during the copolymerization. Suitable organic solvents are solvents in which all monomers in the monomer mixture and the resulting copolymer dissolve at polymerization conditions. In various embodiments, the organic solvent is an oxygenated organic solvent such as for example an alcohol, glycol ether, glycol ester, alkyl acetate, ketone, ester, or glycol ether/ester. For example, the solvent may be a glycol ether or an alkyl acetate. In another embodiment the solvent is N-methyl pyrrolidone (NMP).

Alternatively, the copolymerization may be carried out as an emulsion polymerization process wherein monomers are emulsified in an aqueous phase and then copolymerized. Emulsion polymerization may be carried out at a temperature in the range of from 15° C. to 90° C.

Any suitable initiator may be used. Suitable initiators are known in the art and include organic peroxides and azo initiators. Examples of azo initiators include azobisisobutyronitrile (AIBN) and 2,2′-azodi(2-methylbutyronitrile) (AMBN).

Examples of suitable organic peroxides include tert-butyl peroxy-3,5,5-trimethylhexanoate, benzoyl peroxide, lauroyl peroxide, di-t-butyl peroxide, acetyl peroxide, t-butyl peroxy 2-ethylhexyl carbonate, t-butyl peroxy octanoate, t-amyl peroxy octanoate, and t-butyl peroxy benzoate. The initiator may be added in any suitable amount, typically up to 6 mol % based on the total moles of ethylenically unsaturated monomers, for example in the range of from 1 to 4 mol %. The total amount of initiator may be added in two or three steps, i.e. a first amount at the start of the polymerization and a further amount during the polymerization reaction.

Optionally, a chain transfer agent is used during polymerization. Any suitable chain transfer agent may be used in a suitable amount. Suitable chain transfer agents are known in the art and include methyl mercaptopropionate, 1-dodecanethiol, 1-octanethiol, thioglycolic acid, 2-hydroxy-1-ethanethiol, and butenediol.

The copolymerization may be carried out batch-wise, i.e. by dosing all monomers and initiator at the start of the polymerization, or by gradually dosing part of the monomers and/or initiator during copolymerization, i.e. at so-called starve-fed conditions.

It has been found that the copolymer thus-obtained has properties that makes it suitable to be used as binder polymer in coating compositions. The binder polymer has a relatively high content of butenolide, a component that can be obtained from renewable feedstock. In particular, a binder polymer with a glass transition temperature in the range of from +67° C. to +88° C., as measured by differential scanning calorimetry (DSC) according to ISO 11357-2 using a heating rate of 20 K/min, can be obtained. A further advantageous property of the binder polymer is that it has a polymer backbone with functionality (at the butenolide monomer) which can be used for crosslinking.

The coating composition may be a solvent-borne or waterborne liquid coating composition, or a powder coating composition, for example a liquid coating composition, more specifically an aqueous liquid coating composition wherein the binder polymer is emulsified in an aqueous liquid phase.

The coating composition may comprise further ingredients commonly used in coating compositions such as color pigments, extender pigments, coalescing solvents, and one or more additives such as for example surfactants, defoaming agents, thickeners, leveling agents, and biocides.

In one aspect, the disclosure relates to a substrate coated with a coating deposited from a coating composition. The substrate may be any suitable substrate, such as for example wood, polymer, composite, metal or mineral substrate. The substrate may be a primed or bare substrate.

The coating composition or radiation-curable coating composition can be used as a single layer applied directly to the substrate, or in multilayer systems, e.g. as a primer, a basecoat, a clearcoat, or a topcoat. The coating composition can be used for various applications, such as coating of wood, electronic appliances, plastic automotive components, food can, or as architectural coating.

The disclosure is further illustrated by means of the following non-limiting examples.

### EXAMPLES

### Measurement Techniques

### Monomer Conversion and Initial Reaction Rate

### Method 1 (Monomer Conversion, Initial Reaction Rate by NMR):

A 40 μL sample was diluted in an NMR tube with CDCl₃ (550-600 μL) for reference. At various time points, 20-40 μL samples were taken from the reaction mixture with a microsyringe and diluted in an NMR tube with CDCl₃ (550-600 μL). All samples were analyzed by ¹H NMR on a 400 MHz spectrometer (typically D1=5, ns=8). After correcting processed spectra for phase and baseline, integration of relevant peaks (one for each monomer) allowed monitoring of conversion. Initial reaction rate was calculated from the sampling over time according to the method described in Hermens et al., Sci. Adv. 2020; 6: eabe0026.

### Method 2 (Monomer Conversion by Solids Content Measurement):

The solids content of the polymer solutions was determined in accordance with ISO 3251 with an initial sample mass of 1.0 g, test duration of 60 minutes, at a temperature of 125° C. The monomer conversion was calculated based on the measured solids content. Remaining monomers evaporated under the test conditions, whilst any polymer formed did not evaporate.

### Determination of Number Average Molar Mass (Mn) and Weight Average Molar Mass (Mw) by GPC

The number average and weight average molecular weights were determined using gel permeation chromatography (GPC) with tetrahydrofuran (THF) (+1% acetic acid) as eluent (1 ml/min) on a styrene-divinylbenzene column using polystyrene standards for calibration.

The Polydispersity Index (PDI) is calculated by dividing the determined Mw over the determined Mn.

### Glass Transition Temperature (Tq)

Tg's were measured by Differential Scanning Calorimetry (DSC) using TA Instruments DSC Q2000 equipment in a modulated way according to ASTM D3418.

A DSC cup filled with 6+/−1 mg sample and an empty DSC reference cup were heated in the Differential Scanning Calorimeter (DSC) in a modulated way (+/−1° C. every 40 seconds) from −80° C. to 110° C. at 5° C./min in two consecutive runs using Helium (50 ml/min) as purge gas. Fourier transformation enables the separation of the modulated heat flow into a heat capacity component (Reversing Heat Flow) and a kinetic component (Non-reversing Heat Flow) allowing to separate different thermal events occurring at the same time.

At the materials Tg (observed in the reversing heat flow curve) the heat capacity of the material changed rapidly resulting in a strong decrease of the reversing heat flow curve over a certain transfer area. The Tg was calculated at the point of inflection (Tg(I)) for both runs.

The following vinyl monomers were used:

| | |
|---|---|
| vinyl neodecanoate (ex. Hexion) | VeoVa 10 |
| vinyl neononanoate (ex. Hexion) | VeoVa 9 |
| n-vinyl pyrrolidone | |
| n-vinyl caprolactam | |
| n-vinyl imidazole | |

The butenolide monomers with the following R¹ groups were used:
C(O)CH₃ (5-acetoxy-2(5H)furanone or “acetoxy butenolide”)
CH₃ (5-methoxy-2(5H)furanone or “methoxy butenolide”)

The following solvents and reagents were used:

| | |
|---|---|
| dichloromethane | DCM |
| dimethylaminopyridine | DMAP |
| ethylacetate | AcOEt |
| tetrahydrofuran | THF |
| 1-methoxy-2-propanol (Dowanol ™ PM) | DowPM |
| N-methyl pyrrolidone | NMP |

The following initiator was used:

| | |
|---|---|
| t-butyl peroxy-3,5,5-trimethylhexanoate | T42S |

### Preparation Examples 1 and 2

### Preparation Example 1

### Acetoxy Butenolide

### 5-oxo-2,5-dihydrofuran-2-yl acetate

Chemical Formula: C₆H₅O₄

Molecular Weight: 142.1100

This product and its synthesis were previously described in: G. C. Resende, E. S. Alvarenga, J. C. G. Galindo, F. A. Macias, J. Braz. Chem. Soc. 2012, 23 (12), 2266-2270. In a flask under N₂ atmosphere, hydroxy butenolide (1 eq., 500 mg, 5.00 mmol, grey solid) was dissolved in dry DCM (25 mL) and cooled to 0° C. with an ice bath. Acetic anhydride (1.6 eq., 754 μL, 7.99 mmol) was added, followed by a solution of DMAP (0.3 eq., 183 mg, 1.50 mmol) in dry DCM (1.5 mL). The mixture was stirred at 0° C. for 1 h and then allowed to warm up to room temperature. TLC (25% AcOEt/hexanes, rev. KMnO₄) showed formation of a new product at Rf=0.37. The clear solution was washed with water (25 mL). After phase separation, the aqueous layer was further extracted with DCM (25 mL). The combined organic extracts were dried with sodium sulfate, filtered on cotton and concentrated under reduced pressure. The residue was purified by automatic column chromatography (15 g SiO₂ cartridge, 10-40% AcOEt/pentane over 20 column volume (CV), using DCM for liquid injection. Concentration of the collected fraction afforded pure acetoxy butenolide as a colorless liquid (506 mg, 3.56 mmol, 71% yield).

### Preparation Example 2

### Methoxy Butenolide

### 5-methoxy-2(5H)-furanone

Chemical Formula: C₅H₅O₃

Molecular Weight: 114.1000

This product and its synthesis were previously described in: Hermens et al., Sci. Adv. 2020; 6: eabe0026. 5-Hydroxy-2(5H)-furanone (100.0 g, 1 mol) was dissolved in 500 mL dry methanol and heated at reflux for 20 h. The conversion was followed by ¹H NMR until all 5-hydroxy-2(5H)-furanone was consumed. The solvent was evaporated under reduced pressure and the crude was distilled under reduced pressure (70° C., 1.0×10⁻² mbar) yielding 5-methoxy-2(5H)-furanone (86.5 g, 0.76 mol, 76%) as a slightly yellow oil.

### Examples 1 to 9

To a screw cap 4-vial equipped with a 10 mm stirbar and a septum were added one of the Preparation Examples 1 or 2 and N-vinyl monomer (2 mmol in total), an internal standard (typically 1,3,5-trimethoxybenzene, 1 mmol) and a solvent (N-methylpyrrolidone, 500 μL, [monomers]=4 M).

The mixture was homogenized, briefly heating if needed (e.g. in case of insoluble monomers), and then a 40 μL sample was diluted in an NMR tube with CDCl₃ (550-600 μL) for reference. The vial was then closed and pre-heated at 120° C. for 1-2 min. Trigonox 42S (60 μmol, 3 mol % versus monomers) was added to the hot mixture via a microsyringe through the septum, corresponding to t=0. At various time points, 20-40 μL samples were taken from the reaction mixture with a microsyringe and diluted in an NMR tube with CDCl₃ (550-600 μL).

Monomer conversion and initial reaction rate were calculated according to Method 1, described above.

TABLE 1

| | | | | Initial | |
|---|---|---|---|---|---|
| | | | | reaction | Combined |
| Example | Vinyl | Butenolide | Molar ratio | rate | conversion after |
| No. | monomer | monomer | Vinyl:Butenolide | [×10⁻³s⁻¹] | 2 hours |
| Ex. 1 | N-vinyl | Methoxy | 3:1 | 7.5 | 99% |
| | pyrrolidone | butenolide | | | |
| Ex. 2 | N-vinyl | Methoxy | 1:1 | 7.2 | 99% |
| | pyrrolidone | butenolide | | | |
| Ex. 3 | N-vinyl | Methoxy | 1:3 | 4.1 | 84% |
| | pyrrolidone | butenolide | | | |
| Ex. 4 | N-vinyl | Acetoxy | 3:1 | 11 | 98% |
| | pyrrolidone | butenolide | | | |
| Ex. 5 | N-vinyl | Acetoxy | 1:1 | 15 | 99% |
| | pyrrolidone | butenolide | | | |
| Ex. 6 | N-vinyl | Acetoxy | 1:3 | 6.7 | 87% |
| | pyrrolidone | butenolide | | | |
| Ex. 7 | N-vinyl | Acetoxy | 1:1 | 4.9 | 95% |
| | caprolactam | butenolide | | | |
| Ex. 8 | N-vinyl | Methoxy | 1:1 | 0.2 | 59% |
| | imidazole | butenolide | | | |
| Ex. 9 | N-vinyl | Acetoxy | 1:1 | 0.6 | 53% |
| | imidazole | butenolide | | | |

The results indicate that high initial reaction rate and high conversion can be achieved when an N-vinyl amide is used a comonomer. Moreover, the identity and molar ratio of the comonomers influences the initial reaction rate and conversion.

### Examples 10 and 11 and Comparative Examples 1 and 2

Binder polymers were prepared by charging butenolide monomer and Dowanol PM in a three-neck round-bottom flask equipped with a reflux condenser. The mixture was heated to a temperature of 125° C. and vinyl monomer and t-butyl peroxy-3,5,5-trimethylhexanoate (Trigonox 42S, ex. Nouryon) in further Dowanol PM was dosed in two hours whilst keeping the temperature at 125° C. under reflux conditions under a nitrogen blanket. Some further initiator was then added, and the reaction continued for one hour; then still further initiator was added and the reaction continued for another hour. The reaction mixture was cooled to room temperature. The calculated solids content (weight of monomers and initiator based on total weight of monomers, initiator, and solvent) was 43 wt %. The molar ratio of butenolide monomer to vinyl monomer was in each case 1:1.

A 200 μm wet film of each of Comp. Ex. 1 and 2 and Ex. 10 and 11 was drawn on a glass plate using a drawing bar. After drying at 23° C. and 50% relative humidity for 7 days the Pendulum hardness (Persoz hardness) was determined according to ISO 1522A. The time for the amplitude of the pendulum to decrease from 12 to 4 degrees was measured.

In Table 2 the measured properties (monomer conversion, Tg, molecular weight distribution, Persoz hardness) are shown for the different binder polymers prepared. Monomer conversion was measured according to Method 2 described above.

TABLE 2

| | | | | | | | | Persoz |
|---|---|---|---|---|---|---|---|---|
| Example | Vinyl | Butenolide | | | | | | hardness [s] |
| No. | monomer | monomer | Conversion | Tg | Mn | Mw | PDI | (ISO 1522) |
| Ex. 10 | N-vinyl | Acetoxy | 100% | 88° C. | 743 | 1333 | 1.8 | * |
| | pyrrolidone | butenolide | | | | | | |
| Comp. | VEOVA 9/ | Acetoxy | 100% | 9° C. | 773 | 1440 | 1.9 | 16 |
| Ex. 1 | 10 (1:1) | butenolide | | | | | | |
| Ex. 11 | N-vinyl | Methoxy | 100% | 67° C. | 698 | 1324 | 1.9 | 185 |
| | pyrrolidone | butenolide | | | | | | |
| Comp. | VEOVA 9/ | Methoxy | 95% | — | 1007 | 2201 | 2.2 | 60 |
| Ex. 2 | 10 (1:1) | butenolide | | | | | | |

* no film formation occured - Persoz hardness not tested

These examples show that using NVP as co-monomer provides increased Tg in the case of acetoxybutenolide monomer when using the same synthetic procedure without affecting the molecular weight distribution. In the case of methoxybutenolide, polymer conversion and coating hardness are shown to be increased where NVP is used as comonomer.

1. A radiation-curable coating composition, comprising a monomer mixture, which monomer mixture comprises:
a) at least one butenolide monomer A, which butenolide monomer is a substituted-5-hydroxy-2(5H)-furanone of general formula (I): 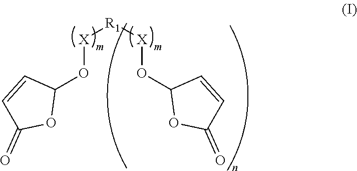
wherein:
n is 0 or an integer of from 1 to 5;
m is 0 or 1;
R¹ is alkyl or aryl;
X is any one of —C(O)—, —C(O)O—, —C(O)NR²—, —S(O)—, —S(O₂)—, —C(O)S—, —C(S)S— and —C(S)NR²—;
wherein R² is hydrogen, alkyl or aryl;
or wherein, when n is 0, R¹ and R² together with the nitrogen atom through which they are linked form a nitrogen-containing heterocyclic group or nitrogen-containing heteroaryl group; and
b) at least one N-vinyl monomer B, which N-vinyl monomer is a compound of general formula (II): 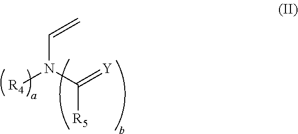
wherein R⁴ and R⁵ are each independently any one of hydrogen, alkyl, aryl, heteroalkyl or heteroaryl and Y is selected from O, NR⁶ and S; wherein R⁶ is hydrogen, alkyl, aryl, heteroalkyl or heteroaryl; wherein any two of R⁴, R⁵ and R⁶ together with the atoms through which they are linked form a nitrogen-containing cyclic heteroalkyl or nitrogen-containing heteroaryl group; and
wherein either: i) a is 1 and b is 1; or ii) a is 0 and b is 2; and
wherein at least one monomer of A and B comprises at least two vinyl groups; and wherein the coating composition is free of a compound with two or more acryloyl or methacryloyl groups.

2. The radiation-curable coating composition according to claim 1, wherein the weight fraction of monomers comprising at least two vinyl groups in the composition is at most 5 wt. %.

3. The radiation-curable coating composition according to claim 1, wherein the composition further comprises c) a photo-initiator.

4. The radiation-curable coating composition according to claim 1, wherein, in general formula (II) a is 1, b is 1, R⁴ and R⁵ together with the atoms through which they are linked form a nitrogen-containing cyclic heteroalkyl or nitrogen-containing heteroaryl group and Y is O.

5. The radiation-curable coating composition according to claim 1, wherein N-vinyl monomer B is N-vinyl pyrrolidone or N-vinyl caprolactam.

6. The radiation-curable coating composition according to claim 1, wherein a is 1, b is 1, Y is NR⁶, and R⁴ and R⁶, together with the atoms through which they are linked form a nitrogen-containing cyclic heteroalkyl or nitrogen-containing heteroaryl group.

7. The radiation-curable coating composition according to claim 6, wherein N-vinyl monomer B is N-vinylimidazole.

8. The radiation-curable coating composition according to claim 1, wherein a is 0, b is 2, Y is O and each R⁵ together with the atoms through which they are linked form a nitrogen-containing cyclic heteroalkyl or nitrogen-containing heteroaryl group.

9. The radiation-curable coating composition according to claim 8, wherein N-vinyl monomer B is N-vinyl phthalimide.

10. The radiation-curable coating composition according to claim 1, wherein n is 0.

11. The radiation-curable coating composition according to claim 1, wherein X is —C(O)—, —C(O)O— or —C(O)NR²—.

12. The radiation-curable coating composition according to claim 1, wherein R¹ is phenyl, C₁-C₂₀ alkyl or C₅-C₇ cycloalkyl.

13. The radiation-curable coating composition according to claim 1, wherein the molar ratio of furanone moieties to vinyl moieties is in the range of from 1.5:1.0 to 1.0:1.5.

14. A monomer mixture, which monomer mixture comprises:
a) at least one butenolide monomer A, which butenolide monomer is a substituted-5-hydroxy-2(5H)-furanone of general formula (I): 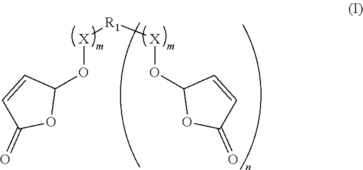
wherein:
n is 0 or an integer of from 1 to 5;
when n is 0, m is 1 and when n is an integer of from 1 to 5, m is 0 or 1;
R¹ is alkyl or aryl;
X is any one of —C(O)—, —C(O)O—, —C(O)NR²—, —S(O)—, —S(O₂)—, —C(O)S—, —C(S)S— and —C(S)NR²—;
wherein R² is hydrogen, alkyl or aryl;
or wherein, when n is 0, R¹ and R² together with the nitrogen atom through which they are linked form a nitrogen-containing heterocyclic group or nitrogen-containing heteroaryl group; and
b) at least one N-vinyl monomer B, which N-vinyl monomer is a compound of general formula (II): 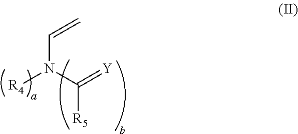
wherein R⁴ and R⁵ are each independently any one of hydrogen, alkyl, aryl, heteroalkyl or heteroaryl and Y is selected from O, NR⁶ and S; wherein R⁶ is hydrogen, alkyl, aryl, heteroalkyl or heteroaryl; wherein any two of R⁵ and R⁶ together with the atoms through which they are linked form a nitrogen-containing cyclic heteroalkyl or nitrogen-containing heteroaryl group; and
wherein either: i) a is 1 and b is 1; or ii) a is 0 and b is 2.

15. A binder polymer obtainable by copolymerizing a monomer mixture as defined in claim 14.

16. A coating composition comprising a binder polymer, which binder polymer is obtainable by copolymerizing a monomer mixture, which monomer mixture comprises:
a) at least one butenolide monomer A, which butenolide monomer is a substituted-5-hydroxy-2(5H)-furanone of general formula (I): 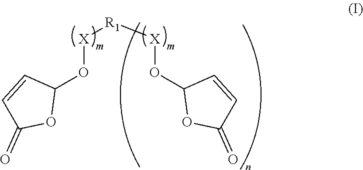
wherein:
n is 0 or an integer of from 1 to 5;
when n is 0, m is 1 and when n is an integer of from 1 to 5, m is 0 or 1;
R¹ is alkyl or aryl;
X is any one of —C(O)—, —C(O)O—, —C(O)NR²—, —S(O)—, —S(O₂)—, —C(O)S—, —C(S)S— and —C(S)NR²—;
wherein R² is hydrogen, alkyl or aryl;
or wherein, when n is 0, R¹ and R² together with the nitrogen atom through which they are linked form a nitrogen-containing heterocyclic group or nitrogen-containing heteroaryl group; and
b) at least one N-vinyl monomer B, which N-vinyl monomer is a compound of general formula (II): 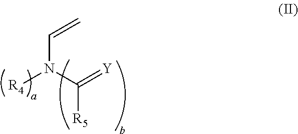
wherein R⁴ and R⁵ are each independently any one of hydrogen, alkyl, aryl, heteroalkyl or heteroaryl and Y is selected from O, NR⁶ and S; wherein R⁶ is hydrogen, alkyl, aryl, heteroalkyl or heteroaryl; wherein any two of R⁴, R⁵ and R⁶ together with the atoms through which they are linked form a nitrogen-containing cyclic heteroalkyl or nitrogen-containing heteroaryl group; and
wherein either: i) a is 1 and b is 1; or ii) a is 0 and b is 2.

17. A substrate coated with a coating deposited from a radiation-curable coating composition as defined in claim 1.

18. A substrate coated with a coating deposited from a coating composition as defined in claim 16.
